(19) United States
(12) Patent Application Publication
(10) Pub. No.: US 2007/0087087 A1
(43) Pub. Date: Apr. 19, 2007

(54) Insulated logistic container and delivery system using such insulated container

(75) Inventors: Ju-Chia Kuo, Hsinchu (TW); Jenn-Chvi Chung, Hsinchu (TW); Huo-Tu Huang, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/417,058

(22) Filed: May 4, 2006

(30) Foreign Application Priority Data
Oct. 14, 2005 (TW) 94135779

(51) Int. Cl. A23B 7/148

(52) U.S. Cl. 426/106

(57) ABSTRACT

An insulated logistic container includes an outer case, an inner case defining a receiving space for holding articles and being located in the outer case, an insulating material disposed in an insulation space formed between the outer and the inner case, and a top cover pivotally connected to a top of the outer case to openably close the receiving space. In a delivery system using such insulated logistic containers to deliver articles to clients, articles having similar product temperatures are positioned in the same insulated container. Eutectic plates or consumptive refrigerant, such as dry ice, is used together with the insulated logistic container to achieve good product temperature control, making the delivery system more efficient and cost-effective, and the insulating effect and the delivery efficiency thereof are improved.

### FIELD OF THE INVENTION

The present invention relates to a logistic container, and more particularly to an insulated logistic container and a delivery system using such insulated containers.

### BACKGROUND OF THE INVENTION

In the current logistics market, foods requiring different storage temperatures are separately delivered using specially designed logistic vehicles. That is, a food to be kept at room temperature is delivered using a logistic vehicle providing a room temperature storage space, and a food to be kept at low temperature is delivered using a logistic vehicle providing a refrigerating or a freezing storage space. However, it is inefficient and ineffective to deliver logistic articles using so many vehicles providing different storage space requirements, particularly when there are so many different types of less than load articles to be delivered. With these difficulties, the investment and transit costs in the logistics business is largely increased.

Moreover, the insulated containers used in the current logistics business have fixed specifications and configurations. Empty insulated containers could not be nested and therefore frequently occupy a very large transport and storage space, which in turn adversely affects the delivery cost and efficiency. The insulated containers holding the delivered articles also occupy quite large room in the delivery destination, such as a store, resulting in waste and limits in space utilization. The conventional insulated logistic container does not withstand high temperature and high-pressure washing water and tends to grow bacteria, which obviously adversely affects the service quality of the logistics business for delivering temperature-controlled foods.

It is therefore desirable to develop an improved insulated logistic container having good insulating performance and capable of withstanding disinfecting and washing, so as to facilitate the logistics management.

### SUMMARY OF THE INVENTION

A primary object of the present invention is to provide an insulated logistic container and a delivery system using such insulated containers, so that the insulating effect and delivery efficiency of the delivery system are improved, making the delivery system more efficient and cost-effective.

To achieve the above and other objects, the insulated logistic container of the present invention includes an outer case, an inner case defining a receiving space for holding articles and being located in the outer case, an insulating material disposed in an insulation space formed between the outer and the inner case, and a top cover pivotally connected to a top of the outer case to openably close the receiving space. Wherein, a plurality of the insulated containers not in use may be opened to expose the receiving space, and then be sequentially nested to occupy only a small storage space.

To meet different storage requirements, the insulted logistic container may include more than one eutectic plate with different freezing point (eutectic point) to enhance the temperature control of the insulated container.

The delivery system using the insulated logistic containers of the present invention includes a plurality of clients, a plurality of insulated logistic containers, common trucks, and a supplier. The supplier provides various kinds of articles. Each of the insulated containers is used to hold articles having the same product temperature. The common trucks carry the insulated logistic containers to delivery the articles in the insulated containers to the clients. The articles of different product temperatures include room-temperature food, fresh food kept at 18° C., chilled food kept at 5° C., cold food kept at −2° C., and frozen food kept at −18° C. With articles having similar product temperature being positioned in the same insulated container, good temperature control of articles having different product temperatures may be achieved, and the insulated containers are not opened on the way to the clients to maintain constant internal temperatures. Moreover, a common truck providing an ambient temperature storage space may be used to carry various kinds of articles having different product temperatures at the same time to reduce the delivery cost and increase the delivery efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view of an insulated logistic container according to an embodiment of the present invention;

FIG. 2 is a perspective view showing a plurality of nested insulated logistic containers of FIG. 1; and

FIG. 3 schematically shows a delivery system using the insulated logistic containers of present invention.

### DETAILED DESCRIPTION OF THE PREFERRED EMBODIMENTS

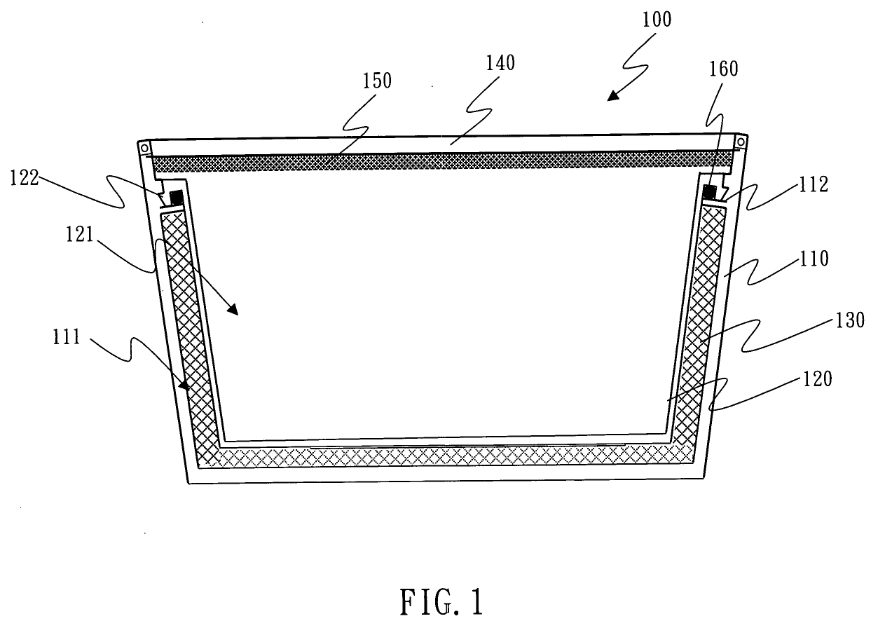

Please refer to FIG. 1 that is a sectional view of an insulated logistic container 100 according to an embodiment of the present invention. To meet actual need, an insulated logistic container may include a eutectic plate to enhance the cold storage effect of the insulated container. The insulated logistic container 100 illustrated in FIG. 1 includes an outer case 110, an inner case 120, an insulating material 130, a top cover 140, and a cold accumulator 150. The inner case 120 defines a receiving space 121 for holding articles, and is located in the outer case 110 with an insulation space 111 formed between it and the outer case 110. The outer case 110 has a first engaging section 112, and the inner case 120 has a second engaging section 122 adapted to fitly and releasably engage with the first engaging section 112, such that the insulated logistic container 100 of the resent invention may be conveniently assembled or disassembled for the purpose of maintenance and repair.

The insulating material 130 is disposed in the insulation space 111. The top cover 140 is pivotally connected to a top of the outer case 110, and can therefore be opened or closed to expose or seal the receiving space 121 in the inner case 120. The eutectic plate 150 is provided at the of the receiving space 121. To ensure an effective air-tightness of the illustrated insulated logistic container 100, an airtight structure 160 is sandwiched between the first and the second engaging section 112, 122 to effectively seal the insulation space 111, preventing washing water from entering the insulation space 111 to adversely affect the performance of the insulating material 130. In the present invention, the airtight structure 160 may be a packing gasket, or a hot welded structure.

The insulating material 130 disposed in the insulation space 111 between the outer and the inner case 110, 120 may be independently replaced. The outer and the inner case 110, 120 may be made of a plastic material with high plasticity, so as to withstand high temperature and/or high-pressure washing water and inhibit the growth of bacteria in the insulated logistic container 100. In the present invention, the insulating material 130 may be a vacuum insulating material or other independently packaged insulating materials. The insulating material 130 together with the airtight insulation space 111 effectively reduce an overall wall thickness of the insulated logistic container 100, expand the usable receiving space 121, and upgrade the insulating performance of the insulated logistic container 100.

Preferably, the inner case 120 and the outer case 110 with the insulating material 130 enclosed therebetween together form an integral sidewall and bottom of the insulated container 100. It is noted the sidewall is not perpendicular to the bottom of the insulated container 100, but slightly outward inclined relative to the bottom. Therefore, a plurality of empty insulated containers 100 may be nested to occupy only a very small storage space.

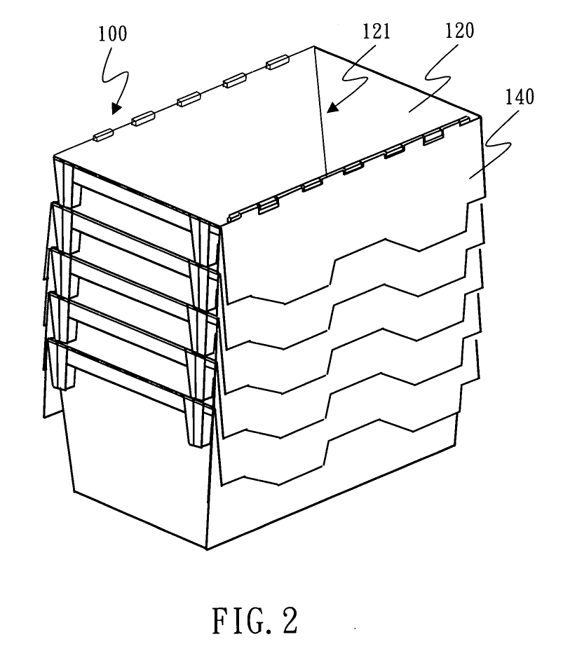

The insulated logistic container 100 of the present invention may be stacked and nested to save the occupied spatial volume and enable increased loading efficiency in delivery as well as increased space utilization at the delivery destination. Please refer to FIG. 2 that shows a plurality of the insulated logistic containers 100 of the present invention in a nested state. When a plurality of the insulated logistic containers 100 are not in use, they may be sequentially nested by open the top covers 140 one by one to expose the receiving spaces 121 in the inner cases 120, and then stack the open-topped insulated logistic containers 100 by sequentially positioning every insulated logistic container 100 in the receiving space 121 of a lower insulated logistic container 100.

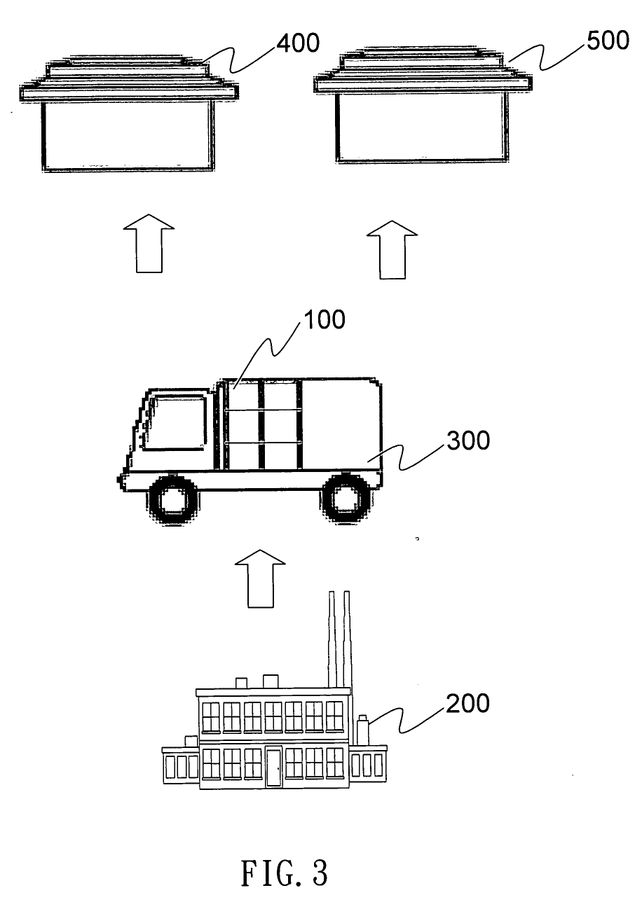

By using the insulated logistic containers 100 of the present invention, it is possible to more efficiently operate a delivery system to deliver various kinds of articles having different product temperatures, such as room-temperature food, fresh food, chilled food, low-temperature food, and frozen food. A supplier of the delivered articles may be an in charge distribution center. Please refer to FIG. 3 that schematically shows a delivery system using the insulated logistic containers 100 of the present invention. The delivery system includes a distributioncenter 200, a plurality of insulated logistic containers 100, common trucks 300, a first client 400, and a second client 500. The distributioncenter 200 supplies various kinds of articles, the plurality of insulated logistic containers 100 are used to receive articles of different product temperatures, and the common trucks 300 carry the insulated logistic containers 100 having articles supplied by the logistics center 200 loaded therein, and deliver the articles in the insulated logistic containers 100 to the first and the second client 400, 500. Wherein, articles having similar product temperature are positioned in the same one insulated logistic container to ensure good temperature control and prevent opening of the insulated logistic containers on the way to the clients, so as to keep every insulated logistic container at a constant internal temperature. With the insulated logistic container 100, the common trucks 300 may be ambient temperature trucks to carry articles of different product temperatures. Thus, the function of delivering articles of different temperatures at the same time could be achieved to reduce the delivery cost.

The present invention has been described with a preferred embodiment thereof and it is understood that many changes and modifications in the described embodiment can be carried out without departing from the scope and the spirit of the invention that is intended to be limited only by the appended claims.

1. An insulated logistic container, comprising:
an outer case;
an inner case defining a receiving space and being located in said outer case with an insulation space formed between said inner and said outer case;
an insulating material disposed in said insulation space; and
a top cover pivotally connected to a top of said outer case to openably close said receiving space in said inner case; and said top cover being provided at a predetermined location with an insulating material; and
said outer case having a first engaging section, and said inner case having a second engaging section adapted to fitly and releasably engage with said first engaging section.

2. The insulated container for logistics purpose as claimed in claim 1, further comprising an airtight structure sandwiched between said first and said second engaging section.

3. The insulated container for logistics purpose as claimed in claim 2, wherein said airtight structure comprises a packing gasket.

4. The insulated container for logistics purpose as claimed in claim 2, wherein said airtight structure comprises a hot welded structure.

5. The insulated container for logistics purpose as claimed in claim 1, further comprising more than one eutectic plate.

6. A delivery system using insulated logistic containers, comprising:
a supplier providing various kinds of articles;
a plurality of insulated logistic containers, each of which being used to receive said articles having similar product temperature;
common trucks for carrying a plurality of said insulated logistic containers to deliver said articles provided by said supplier; and
a plurality of clients accepting said articles of different product temperatures delivered by said common trucks.

7. The delivery system using insulated logistic containers as claimed in claim 6, wherein said articles include room-temperature food, fresh food, chilled food, cold food, and frozen food.

8. The delivery system using insulated logistic containers as claimed in claim 6, wherein said supplier is a distribution center, a transit center, a factory, a farm, or a business office.

9. The delivery system using insulated logistic containers as claimed in claim 6, wherein said insulated logistic container includes:
an outer case;
an inner case defining a receiving space for holding said articles having similar product temperature; said inner case being located in said outer case with an insulation space formed between said inner and said outer case;
and insulating material disposed in said insulation space; and
a top cover pivotally connected to a top of said outer case to openably close said receiving space in said inner case; and
said outer case having a first engaging section, and said inner case having a second engaging section adapted to fitly and releasably engage with said first engaging section.

10. The delivery system using insulated logistic containers as claimed in claim 9, further comprising an airtight structure sandwiched between said first and said second engaging section of said insulated logistic container.

11. The delivery system using insulated logistic containers as claimed in claim 9, further comprising more than one cold accumulator on said insulated logistic container.

12. The delivery system using insulated logistic containers as claimed in claim 9, wherein said insulated logistic container includes an airtight structure.

13. The delivery system using insulated logistic containers as claimed in claim 9, wherein said airtight structure is a hot welded structure.

14. The delivery system using insulated logistic containers as claimed in claim 9, wherein said airtight structure is a packing gasket.

15. An insulated logistic container, comprising:
an outer case;
an inner case defining a receiving space and being located in said outer case with an insulation space formed between said inner and said outer case;
an insulating material disposed in said insulation space; and
a top cover pivotally connected to a top of said outer case to openably close said receiving space in said inner case; and said top cover being provided at a predetermined location with an insulating material; and
said inner and said outer case having said insulating material enclosed therebetween forming an integral sidewall and bottom of said insulated logistic container, and said sidewall being outward inclined relative to said bottom instead of being perpendicular to said bottom.

16. The insulated logistic container as claimed in claim 15, wherein said outer case has a first engaging section, and said inner case has a second engaging section adapted to fitly and releasably engage with said first engaging section.

17. The insulated logistic container as claimed in claim 16, further comprising an airtight structure sandwiched between said first and said second engaging section.

18. The insulated logistic container as claimed in claim 17, wherein said airtight structure is a packing gasket.

19. The insulated logistic container as claimed in claim 17, wherein said airtight structure is a hot welded structure.

20. The insulated logistic container as claimed in claim 19, further comprising more than one eutectic plate.
